(19) United States
(12) Patent Application Publication
(10) Pub. No.: US 2011/0174955 A1
(43) Pub. Date: Jul. 21, 2011

(54) MOUNTING APPARATUS FOR STORAGE DEVICE

(75) Inventors: CHUNG-CHENG HSIEH, Tu-Cheng (TW); LI-PING CHEN, Tu-Cheng (TW)

(73) Assignee: HON HAI PRECISION INDUSTRY CO., LTD., Tu-Cheng (TW)

(21) Appl. No.: 12/793,660

(22) Filed: Jun. 3, 2010

(30) Foreign Application Priority Data
Jan. 18, 2010 (CN) 201020300897.7

(51) Int. Cl. F16M 13/02

(52) U.S. Cl. 248/636; 248/231.81

(57) ABSTRACT

A mounting apparatus for a storage device comprises a chassis configured for receiving the storage device and a securing member configured for securing the storage device. The chassis defines a positioning pin, for engaging in a positioning slot defined in the storage device, and an elastic piece mounted on the chassis. The elastic piece is elastically deformed when the securing member is engaged with the storage device and capable of rebounding to drive the storage device to move away from the wall when the securing member is disengaged from the storage device.

### BACKGROUND

1. Technical Field

The present disclosure relates to a mounting apparatus for mounting a storage device.

2. Description of Related Art

In a conventional computer, a storage device is typically secured to a drive bracket with screws. A significant drawback to this means is that the insertion and removal of screws is cumbersome and time consuming. In addition, a tool such as a screwdriver is usually required. Moreover, the screws can be accidentally lost during assembly or disassembly.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a partially, exploded view of a mounting apparatus for a storage device in accordance with an embodiment.

FIG. 2 is an isometric view of the storage device of FIG. 1.

FIG. 3 is an assembled view of the mounting apparatus of FIG. 1.

FIG. 4 is an assembled view of the mounting apparatus and the storage device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

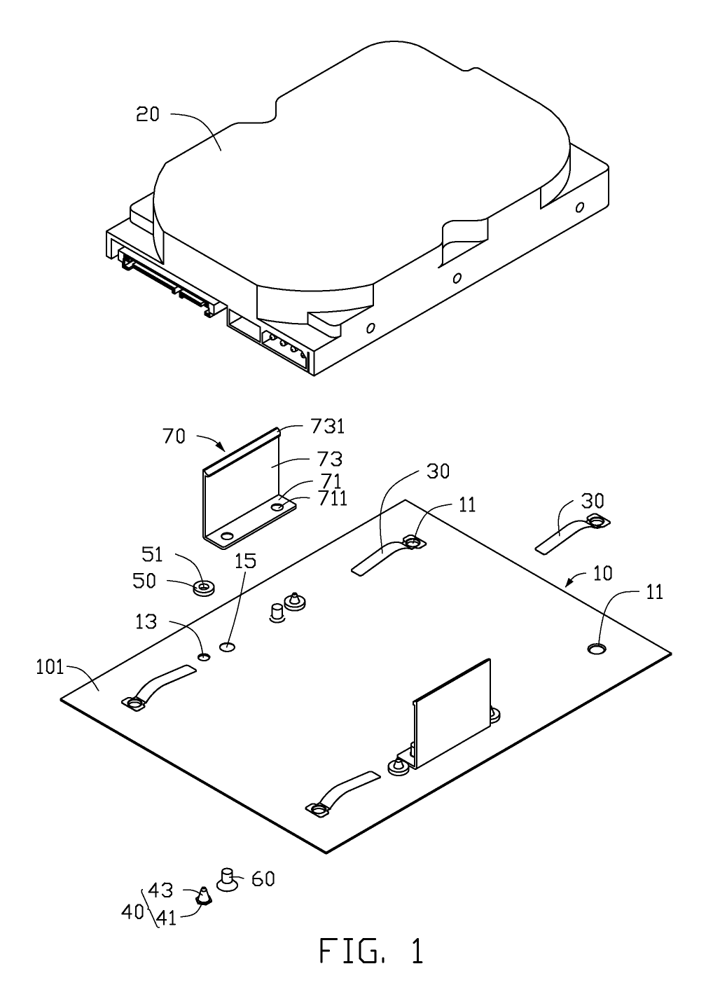

Referring to FIG. 1, a mounting apparatus in accordance with an embodiment includes a chassis 10. The chassis 10 is configured for enclosing a plurality of electronic elements, such as a motherboard, a power supply, expansion cards, a storage device 20 and so on. In one embodiment, the storage device 20 can be a hard disk, or an optical disk drive. The chassis 10 includes a wall 101. The wall 101 may be a bottom wall, or a sidewall, for example.

Four securing holes 11, four positioning holes 13, and four mounting holes 15 are defined in the wall 101 of the chassis 10. The four securing holes 11 are located at four corners of a square area of the wall 101. Each positioning hole 13 is near to each securing hole 11, and each mounting hole 15 is near to each positioning hole 13. An elastic piece 30 is mounted to each securing hole 11. The center of the elastic piece 30 is away from an upper surface of the wall 101 of the chassis 10, and a gap is defined the center of the elastic piece 30 and the upper surface of the wall 101.

Each positioning hole 13 is used to receive a positioning pin 40. The positioning pin 40 comprises a hexagonal securing portion 41 and an extending portion 43 connected to the securing portion 41. In one embodiment, the positioning pin 40 is cone-shaped. The securing portion 41 is capable of engaging with the lower surface of the wall 101 of the chassis 10. The extending portion 43 is capable of passing through the positioning hole 13 to expose out of the upper surface of the wall 101 of the chassis 10.

A washer shaped vibration absorbing member 50 is fit around each extending portion 43 of each positioning pin 40 through holes 51 defined therein and abut against the upper surface of the wall 101. The vibration absorbing members 50 are capable of absorbing vibrations generated by the storage device 20. In one embodiment, the vibration absorbing members 50 are made of resilient materials.

Each mounting hole 15 is used to receive a fixing member 60. The fixing members 60 are used to mount two securing members 70. Each securing member 70 comprises a securing plate 71 fixed to the wall 101, and a clipping plate 73 extends from an edge of the securing plate 71. In one embodiment, the angle of the securing plate 71 and the clipping plate 73 is less than 90 degrees. Each securing plate 71 defines two screw holes 711 corresponding to the mounting holes 15 of the wall 101. A clipping portion 731 is disposed on the upper edge of each clipping plate 73. The clipping plate 73 can be elastically deformed to stretch outwards, and can rebound inwards to secure the clipping portion 731 to the top of the storage device 20.

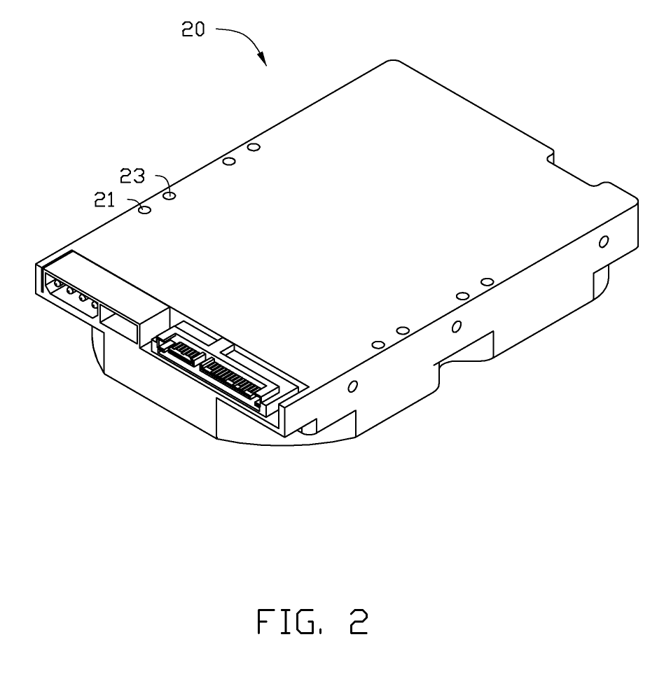

Referring to FIG. 2, the storage device 20 defines four positioning slots 21 corresponding to the positioning holes 13 and four fixing slots 23 corresponding to the fixing members 60. The fixing slot 23 is configured for receiving the extending portion 43 of the positioning pin 40.

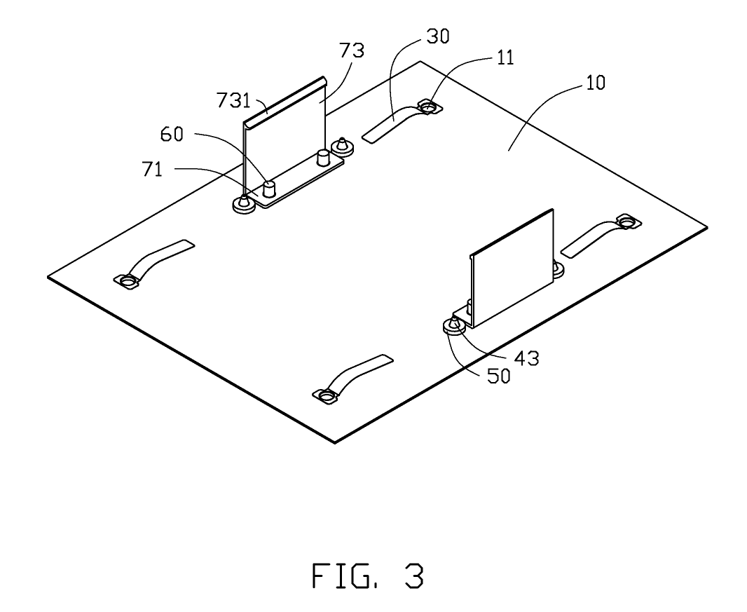

Referring to FIG. 3, in assembly, the four elastic pieces 30 are mounted to the securing holes 11 of the wall 101. Each positioning pin 40 passes through each positioning hole 13 from the lower surface of the wall 101 of the chassis 10 to the upper surface. The vibration absorbing members 50 are secured to the extending portions 43 of the positioning pins 40. Each securing member 70 is placed on the wall 101 of the chassis 10. The screw holes 711 of the securing plate 71 are aligned with mounting holes 15 of the wall 101 of the chassis 10, and the fixing members 60 are screwed into the screw holes 711 and the mounting holes 15, to mount the securing member 70 to the wall 101.

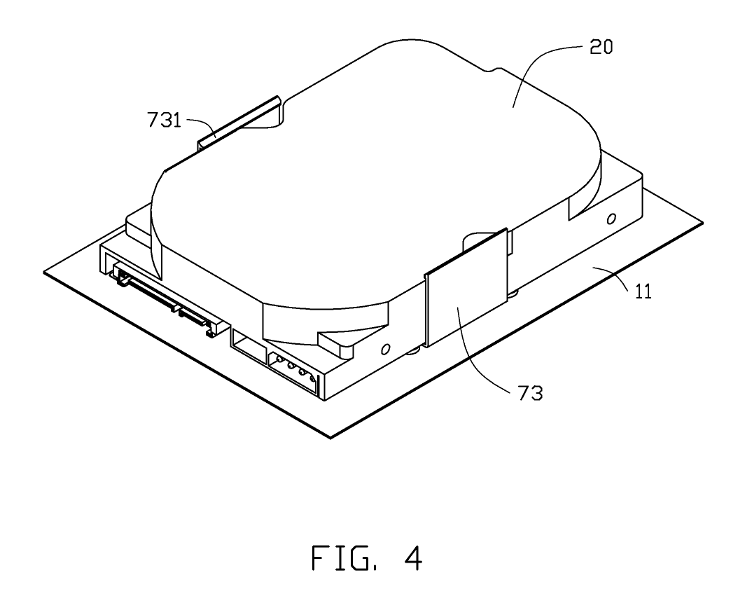

Referring also to FIG. 4, in assembly of the storage device 20, the storage device 20 abuts against the clipping portion 731 of each securing member 70. When the storage device 20 is further pushed in clipping portion 731, the clipping plate 73 is elastically deformed to stretch outwards. The storage device 20 is further moved down, until the positioning slot 21 receives the extending portion 43 of the positioning pin 40, and the fixing slot 23 receives the fixing member 60. At this time, each elastic piece 30 is elastically deformed by the storage device 20. When the storage device 20 crosses the clipping portion 731 of the clipping plate 73, the clipping plate 73 rebounds to secure the clipping portion 731 to the top of the storage device 20. Therefore, the clipping portion 731 clips to the edge of the upper surface of the storage device 20. In this way, the storage device 20 is located between the two clipping plates 73 of the two securing members 70, and the vibration absorbing members 50 are located between the storage device 20 and the wall 101 of the chassis 10.

In disassembly of the storage device 20, the two clipping plates 73 are actuated to resiliently deform away from the storage device 20, and the two clipping portions 731 of the two clipping plates 73 are moved away from the storage device 20. Then, the four elastic pieces 30 mounted on the chassis 10 rebound and move the storage device 20 away from the wall 101 of the chassis 10. Thus, the storage device 20 can be removed from the wall 101.

In use, all the elastic pieces 30 and the vibration absorbing members 50 are capable of absorbing vibrations of the storage device 20.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A mounting apparatus for a storage device, the mounting apparatus comprising:
a chassis comprising a wall, a positioning pin located on the wall and configured for engaging into a positioning slot defined in the storage device;
a securing member mounted on the wall and configured for clipping the storage device; and
an elastic piece mounted on the wall, the elastic piece is elastically deformed when the securing member is engaged with the storage device and capable of rebounding to drive the storage device to move away from the wall when the securing member is disengaged from the storage device.

2. The mounting apparatus of claim 1, wherein the securing member comprises a securing plate mounted on the wall and a clipping plate configured for engaging with the storage device, and the clipping plate extends from the securing plate.

3. The mounting apparatus of claim 2, wherein a clipping portion is located on the clipping plate, and the clipping portion is configured for clipping the storage device.

4. The mounting apparatus of claim 1, wherein a gap is defined between the elastic member and the wall.

5. The mounting apparatus of claim 1, wherein the elastic member is located at a corner of the wall.

6. The mounting apparatus of claim 1, wherein a vibration absorbing member is secured on the positioning pin for supporting the storage device.

7. The mounting apparatus of claim 1, wherein the positioning pin comprises a securing portion and an extending portion connected to the securing portion, the securing portion abuts the wall, and the extending portion passes through the wall.

8. The mounting apparatus of claim 1, wherein a fixing member passes through the securing member for engaging in a fixing slot defined in the storage device.

9. A mounting apparatus for a storage device, the mounting apparatus comprising:
a chassis comprising a wall, the wall defining a positioning pin for engaged into a positioning slot of the storage device;
a securing member comprising a securing plate mounted to the wall and a clipping portion extends from an edge of the securing plate, a clipping portion defined on the securing plate to clip to the storage device, and
an elastic piece mounted on the wall to abut against the storage device, and a gap defined between the center of the elastic piece and the upper surface of the wall.

10. The mounting apparatus of claim 9, wherein the angle of the securing plate and the clipping plate is an acute angle.

11. The mounting apparatus claim 9, wherein the elastic member is located at a corner of the wall.

12. The mounting apparatus claim 9, wherein a vibration absorbing member is secured on the positioning pin and located between the storage device and the wall.

13. The mounting apparatus claim 9, wherein the positioning pin comprises a securing portion and an extending portion connected to the securing portion, the securing portion abuts to the wall, and the extending portion passes through the wall to expose out of the wall

14. The mounting apparatus for a storage device of claim 9, wherein a fixing member passes through the securing member for engaging in a fixing slot defined in the storage device.

15. A mounting apparatus comprising:
a chassis comprising a wall having a positioning pin;
a securing member mounted on the wall; and
an elastic piece mounted on the wall, the elastic piece is elastically deformed when the securing member is engaged with the storage device and capable of rebounding to drive the storage device to move away from the wall when the securing member is disengaged from the storage device.

16. The mounting apparatus of claim 15, wherein the securing member comprises a securing plate mounted on the wall and a clipping plate configured for engaging with the storage device, and the clipping plate extends from the securing plate.

17. The mounting apparatus of claim 15, wherein a clipping portion is located on the clipping plate, and the clipping portion is configured for clipping the storage device.

18. The mounting apparatus of claim 15, wherein a gap is defined between the elastic member and the wall.

19. The mounting apparatus of claim 15, wherein a vibration absorbing member is secured on the positioning pin for supporting the storage device.

20. The mounting apparatus for a storage device of claim 15, wherein a fixing member passes through the securing member for engaging in a fixing slot defined in the storage device.
